(19) United States
(12) Patent Application Publication
(10) Pub. No.: US 2014/0205117 A1
(43) Pub. Date: Jul. 24, 2014

(54) SYSTEM AND METHOD FOR FITTING HEARING DEVICES

(71) Applicant: OTOTRONIX LLC, HOUSTON, TX (US)

(72) Inventor: ZEZHANG HOU, Cupertino, CA (US)

(73) Assignee: OTOTRONIX LLC, HOUSTON, TX (US)

(21) Appl. No.: 14/160,802

(22) Filed: Jan. 22, 2014

Related U.S. Application Data
(60) Provisional application No. 61/849,120, filed on Jan. 22, 2013.

(51) Int. Cl. H04R 25/00

(52) U.S. Cl. CPC H04R 25/70
USPC 381/312

(57) ABSTRACT

An improved method and apparatus for automatic haring device fitting have been disclosed. The disclosed apparatus includes a search engine for searching the optimal settings of a hearing device, a first selector for patient to alternate the hearing device between two presets, and a second selector for patient to register the preference or no preference to the two presets. The search engine includes the tie-break component for deciding which preset is better when patient cannot tell the difference between presets. The disclosed method includes a search engine for searching the optimal settings of a hearing device, a first mean for patient to alternate the hearing device between two presets, and a second mean for patient to register the preference or no preference of the two presets. The method may be implemented as a computer software program or as a standalone apparatus for controlling and programming hearing devices. It may also be incorporated in a hearing device itself. The disclosed hearing device compromises at least one microphone for converting acoustical signal into electronic signals, an electronic circuit for processing the electronic signals to produce processed electronic signals, a transducer for converting the processed electronic signals into signals having another type of energy format, a communication interface for receiving patient selections from an external apparatus, and a search engine for searching the optimal setting for the hearing device.

### RELATED APPLICATIONS

This application claims the benefit, under 35 U.S.C. §119 (e) of U.S. Provisional Patent Application Ser. No. 61/849,120, filed on Jan. 22, 2013. Patent Application Ser. No. 61/849,120 is pending as of the filing date of this application. The contents of Application Ser. No. 61/849,120 are fully incorporated herein by reference.

### FIELD OF THE INVENTION

The present invention relates to hearing devices (hearing aids or assistive listening devices), hearing device design, hearing device fitting, and software and apparatus for controlling and programming hearing devices.

### BACKGROUND OF THE INVENTION

A typical hearing fitting procedure includes obtaining patient's hearing loss information, calculating an initial set of values to set up hearing aid parameters for the patient (often referred to as the first fit), making additional adjustment to the parameters based on patient reaction or comments.

Patients hearing loss information can be obtained using commercial available audiometric equipment such as a standard audiometer. It can also be obtained from otoacoutstic emission or auditory brainstem response. Some hearing aids have a built-in function which can be used to obtain in situ hearing loss information.

The first fit is calculated using the hearing loss information. The formulae are based on the understanding of hearing loss, characteristics of a hearing device, and/or clinical results with the hearing devices under consideration.

The additional adjustment is often necessary because the first fit may be a good fit for average patients, but may not be the best fit for an individual patient. Most adjustments are made manually. In order to make a right adjustment, a fitter needs to have a good understanding of the hearing device and its control software, and a good assessment of patient comment on the current settings. There have been studies on automatic adjustment procedures in which a patient can interact with hearing fitting software or a fitting apparatus to set up their own hearing devices.

A commonly used strategy is paired comparison in which patient is asked to compare a pair of settings selected from a large group of presets and decide which of the two setting he/she prefers. The comparison would continue in an iterative round robin, double elimination tournament, or modified simplex procedure until it produces a winner which would be the optimal setting for the patient. The effectiveness of the paired comparison procedure is largely dependent on the selection of presets and on the patient's ability to decide their preference. The selection of presets is largely based on patient hearing loss profile and adjustable range of parameters with the hearing devices. There is no standard method to define the presets. In many cases, the group of presets is large in order to cover the full fitting range. This makes the paired comparison extremely time consuming. In addition, patients often cannot tell the difference between some of pairs in the testing conditions they are given, making it impractical to use the conventional paired comparison.

US patent application publication 2010/0172524 described a modified paired comparison method and its applications. In this method, the paired comparison is conducted adaptively for more than one group of presets. The first group is selected based on the knowledge of patient hearing loss and available range of device fitting parameters. The subsequent group is constructed by combining new presets with the winning presets of the comparison results for the previous group. The new presets are created using crossover and mutation operations modeled after the biological behavior of genetic evolution where parent chromosomes line up and crossover by swapping portion of their genetic code or become muted. The procedure continues until it converges to a preset that will be the optimal setting for the patient. The application claims the method converges fast and is more practical to be used in the field without professional supervision. However, the application does not address the problem that patient often cannot tell the difference between some presets in acoustical environments they are testing the devices. In addition, the construction of the new groups of presets is largely dependent on mathematic operations. Professional knowledge about the relationship between patient needs and hearing aid settings is not built into the adaptation procedure and therefore the procedure is still not very efficient.

There is a need for a practical and efficient solution of automatic fitting procedure so that a patient can interact with a computer or an apparatus to set up their hearing devices.

### SUMMARY OF THE INVENTION

Broadly speaking, the present invention relates to hearing devices (hearing aids or assistive listening devices), hearing device design, and hearing device fitting. More specifically, it relates to fitting system that may be implemented in computer software or as stand-alone apparatus for controlling and programming hearing devices. It may also be incorporated in a hearing device itself.

The disclosed fitting method is intended to assist patients, with or without help from audiologists or trained technicians, to find the best settings for their hearing aids. The method is similar to the one used by optometrists for eyeglasses fitting. The core of the method is an improved paired comparison, in which patients listen to sound samples with the hearing device toggling between a pair of presets and select the preset they prefer. If the patient cannot tell the difference, the fitting software or fitting apparatus will decide which one is better based on which preset produces a higher intelligibility score. The software will automatically pair the next two presets based on a patient's response to the previous one. Sound samples can be speech only, speech in noise, and/or music which is presented at a normal level, or live conversations with the fitter or a helper such as patient's spouse.

In one preferred embodiment according to the present invention, a software program, or an apparatus for fitting hearing device includes:
a search engine for searching the optimal settings of a hearing device;
a first selector for the patient to alternate the hearing aid between two presets;
a second selector for the patient to register the preference or no preference of the two presets; and
the said search engine includes a tie-break component for deciding which preset is better if patient registers a no preference response.

The search engine is critical in producing an optimal setting. The search engine is described in more detail on pages 10-12. The search engine also determines if a fitting procedure is efficient and converging. It can use available information on patient hearing loss and knowledge about the relationship between hearing device settings (such as gain response) and the hearing loss to compute the initial preset.

A preset is a set of values for setting up adjustable parameters of the hearing device. For an example, a preset can be a set of gain values for frequencies between 125 Hz and 8000 Hz. It can also be a set of values related to frequency gains. The calculation of the initial preset of frequency gain is known in the art as fitting algorithm, fitting formula, or fitting prescription. After the initial preset is obtained, a list of additional presets can be derived from the initial preset using mathematic manipulations. For an example, a new preset can be the initial preset plus a variation number.

In one preferred embodiment, the said search engine includes a calculation of an initial preset from patient hearing loss and creation of additional presets.

In one preferred embodiment, the list of additional presets compromises volume variation of the initial presets.

After obtaining the initial preset and a list of the additional presets, the search engine operates to perform paired comparison that allows patient to select one of three answers: prefer the first preset, prefer the second preset, or no preference. The paired comparison progresses in a way similar to iterative round robin, double elimination tournament, or modified simplex procedure. Alternatively, it may progress based on the understanding of each presets. For example, if presets A and B only differ in the overall volume with A<B, and patient already prefers B over A, the search engine can operate to skip all comparisons between B and presets that have less overall volumes than A. This will make the search engine operates more efficiently.

A fitting session can consists of one or more rounds of paired comparisons described above. In one preferred embodiment, the initial round(s) of paired comparisons are executed with a large step size between presets, and the following round(s) of paired comparisons are executed with a small step size.

The fitting procedure described above can be used to set up multiple programs for underlining hearing devices using different sound samples during the paired comparison operation. For example, speech sound samples can be used to set up a program for listing to speech. Speech in noise sound samples can be used to set up a program for listening to speech in noise environment. Music samples can be used to set up a program for listening to music. Furthermore, different styles of music (e.g., classic, jazz, country, etc.) can be selected for patients who may have a preference for specific music type.

In another preferred embodiment, the search engine described above is implemented in the hearing device itself, and the fitting apparatus is simplified to only include the control panel and communication interface.

### BRIEF DESCRIPTION OF THE DRAWINGS

The above, as well as other advantages of the present invention, will become readily apparent to those skilled in the art from the following detailed description when considered in the light of the accompanying drawings in which like numerals designate corresponding parts in the several views.

FIG. 1A shows two major components of an apparatus for fitting hearing devices according to the present invention.

FIG. 1B shows two major components of a software program for fitting hearing devices according to the present invention.

FIG. 2 is an example of control panel of fitting software or fitting apparatus according to the present invention.

FIG. 3 is a flow chart showing the operation procedure of the search engine for the fitting software or fitting apparatus according to one preferred embodiment of the present invention.

FIG. 4 is an example of how to prepare the first pair of presets for the search engine illustrated in FIG. 3.

FIG. 5 is an example of how to prepare the new pair of presets for the search engine illustrated in FIG. 3 if preset A was preferred in the previous iteration of paired comparison.

FIG. 6 is an example of how to prepare the new pair of presets for the search engine illustrated in FIG. 3 if preset B was preferred in the previous iteration of paired comparison.

FIG. 7 illustrated a hearing device and communication apparatus according to the present invention.

### DETAILED DESCRIPTION OF THE PREFERRED EMBODIMENTS

The invention relates to the hearing devices (hearing aids or assistive listening devices), hearing devices design, and hearing device fitting. More specifically, it relates to fitting method that can be implemented in software and apparatus for programming and controlling hearing devices. Alternatively, it can be implemented in the hearing device itself. The invention will be readily understood by the following detailed description in conjunction with the accompanying drawings which form part of specific embodiments.

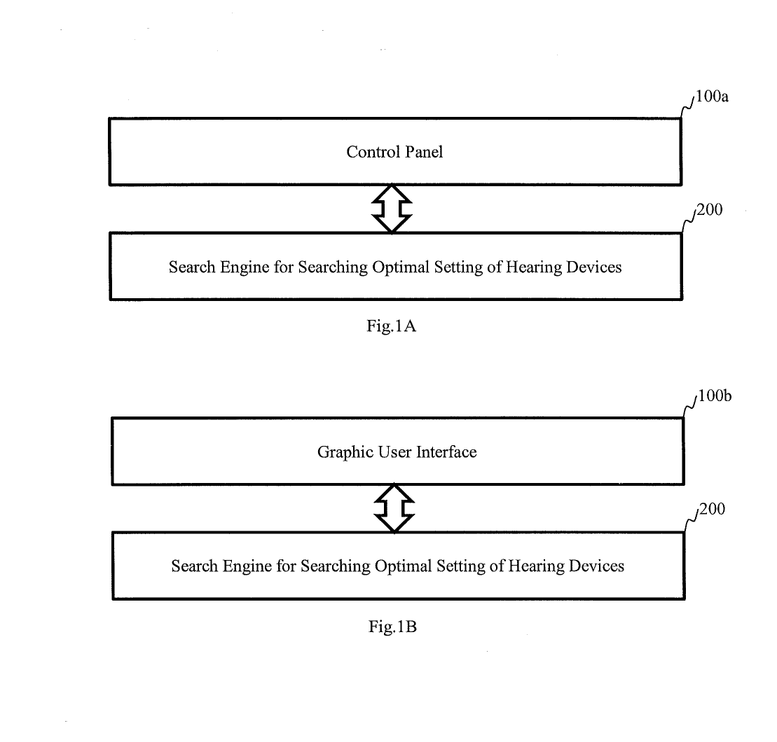

With reference to FIG. 1A, an apparatus for fitting hearing devices includes a control panel 100a for patient to control the hearing device and register his/her input, and a search engine 200 for searching an optimal setting for the hearing device designated for the patient. The said apparatus can further compromise other standard components such as power supply, on/off switch, memory, state machine, and CPU, etc. It also compromise components for communicating and exchanging data with the hearing devices, via either wired cables or wireless links. It can further include components for conducting in-situ hearing test for patients using the underling devices. Furthermore, it may be extended to include components for receiving patient's hearing loss data such as hearing thresholds at one or more frequencies.

With reference to FIG. 1B, a software program for fitting hearing devices includes a user interface 100b for patient, with or without a trained fitter's assistance, to control the hearing device and register his/her input, and a search engine 200 for searching an optimal setting for the hearing device designated for the patient. The said software program can run on a computing device such as a personal computer or smartphone. It can further comprise other standard components such as modules for taking patient identification and hearing loss information, modules for displaying spec information for hearing devices, modules for a fitter to manually adjust parameters of hearing devices, and modules to communicate and exchange data with hearing devices directly or indirectly via wired cables or wireless links. It can further include modules for conducting in-situ hearing test for patients using the underling devices.

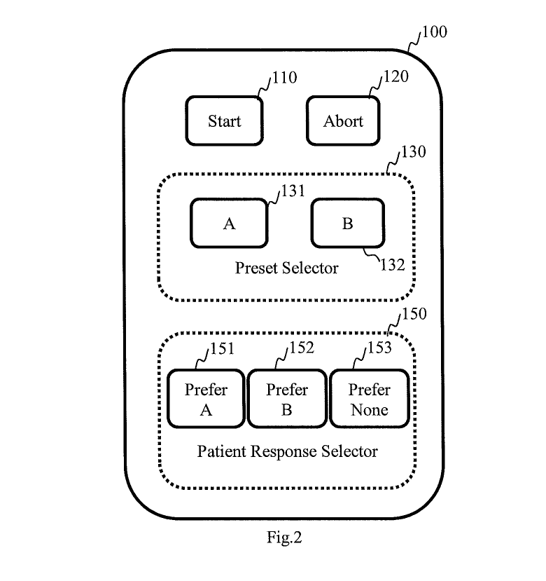

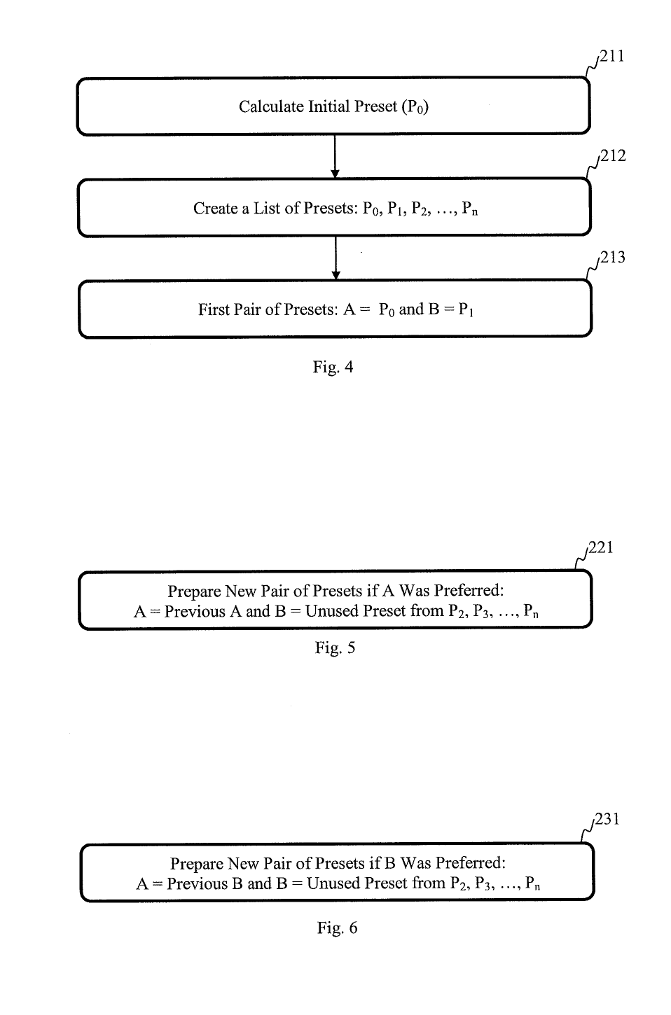

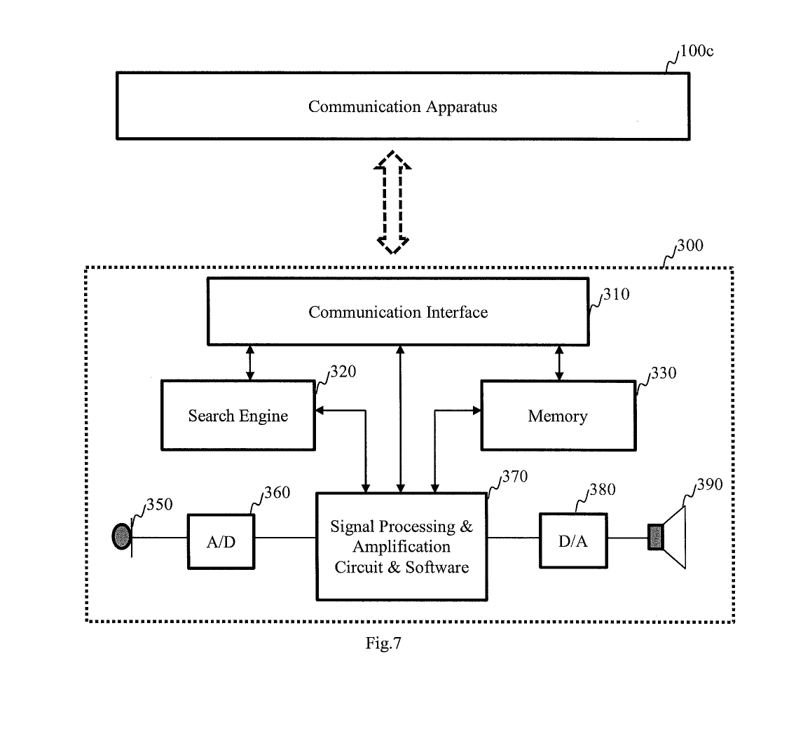

With Reference to FIG. 1A, FIG. 1B, and FIG. 2, control panel of an apparatus 100a or user interface of a software program 100b for fitting hearing devices may include a Start button 110. The searching process of the search engine begins after the Start button is pressed. After the searching process starts, the searching procedure outlined in is executed. The procedure can be stopped anytime by pressing the Abort button 120. With further reference to, once the searching procedure starts (Box 201), the first pair of presets are prepared for patient to conduct paired comparison (Box 210). A preset is set of values to be sent to the hearing device in order for the hearing device to behave in a desired manner. For example, it can be a set of gain values at one or more frequencies such as 250, 500, 1000, 2000, 4000, and 6000 Hz. A gain value can be a number in decibel (dB) or a number that related to the decibel such as an index. One of preferred embodiments for preparing the first pair of presets is illustrated in FIG. 4. First, an initial preset, P₀, is created (Box 211). The initial preset can be a set of fixed numbers or calculated numbers based on the hearing loss information of the underlying patient. The hearing loss information can be the one obtained from an in-situ hearing test using the hearing device and the fitting apparatus or software 100, or the one obtained via standard audiometers and entered into the fitting apparatus or the fitting software 100.

The apparatus and software program illustrated in FIGS. 1A, 1B, and 2, can be easily extended to include the mechanisms for receiving the hearing loss information, which is well known in the art and beyond the scope of the present invention. Similarly, the calculation of an initial preset from hearing loss information is known in the art as fitting algorithm, fitting prescription, or fitting formula, and is also beyond the scope of the present invention.

After the initial preset is obtained, a list of additional presets, P₁, P₂, . . . , Pₙ, can be derived (Box 212). The additional presets can be a set of fixed values independent of the initial preset, or a set of calculated values obtained through mathematic manipulations of the initial preset. For an example, a new preset can be the initial preset plus a number.

After the list of presets is created, the first pair of presets is selected from the list (Box 213). For example, one preset of the first pair is the initial preset and the other preset is one of the remaining presets in the list.

After the first pair of presets is prepared, one or both presets are transmitted into the hearing device. Patient can alternate between the two presets while listening to the device (Box 240) by pressing one of Preset Selector buttons A (Box 131) or B (Box 132). When button A (Box 131) is pressed, the hearing device operates with preset A. When button B (Box 132) is pressed, the hearing device operates with preset B. Patient can go back and forth between the A and B as many time as he/she wants to compare the two presets before making a decision on which preset is preferred or there is no difference. The decision can be registered using Patient Response Selector (Box 150). If the patient prefers A, the Prefer A (Box 151) button is pressed. If the patient prefers B the Prefer B (Box 152) button is pressed. If there is no difference the Prefer None (Box 153) button is pressed. After the patient make the selection on the control panel or the graphic user interface, the search engine 200 receives the response at Receive Patient Response 250.

At this point, a decision logic “Found Optimal Setting?” 260 will decide if an optimal setting has been found. The decision logic may be implemented in various different formats. For example, it can be a logic that checks if the current pair is the last pair. If it is, the current preferred preset is the optimal setting for the hearing device. If there is no preference from the current comparison, the preset that produces higher intelligibility score can be set as the optimal setting for the hearing device. As another example, the decision logic is a process that checks if the remaining presets that have not been used in the comparison can be eliminated based on the comparison results this far. For example, if presets A and B only differ in the overall volume with A<B, and patient already prefers B over A, and if the remaining presets has less overall volume that A, they can be eliminated. This is referred to as monotonic rule of volume. If the decision logic 260 decides that the optimal setting has been found, the search for optimal setting is done at 299. If not, the search engine 200 proceeds to check what patient's response is at block 270. If patient's response was Prefer A or Prefer B, the search engine proceeds to Prepare New Preset Pair (Box 220 or 230, respectively), then goes back to Box 240 to continue the paired comparison procedure. If the patient's response was No Preference (i.e. Prefer None), the search engine proceeds to Tie-Break block (Box 280). The tie break block decides which preset would benefit the patient better based on some objective calculation. For example, it may calculate the speech intelligibility index (SII) (ANSI S3.5-1977) or articulation index (AI)(ANSI S3.5-1969) for the two presets. If preset A produces a higher score, the search proceeds to Prepare New Preset Pair (Box 220), as in the case that patient's response was Prefer A, and continues. If preset B produces a higher score, the search proceeds to Prepare New Preset Pair 230, as in the case that patient's response was Prefer B, and continues.

At Block 220, a new pair of presets is prepared knowing that the patient's response was Prefer A. In one preferred embodiment shown in Block 221 of FIG. 5, the Prepare New Preset Pair 220 produces a pair of presets, one of which is the preset A from the previous comparison that was just finished, and the other is a new preset from the list of remaining presets that have not been used in all of previous comparisons. In another embodiment, the Block 220 draws two presets from the list of all presets that have not been compared against each other. Furthermore, audiologic rules such as the monotonic rule of volume can be incorporated to reduce the number of comparisons.

At Block 230, a new pair of presets is prepared knowing that the patient's response was Prefer B. In one preferred embodiment shown at 231 of FIG. 6, the Prepare New Preset Pair (Box 230) produces a pair of presets, one of which is the preset B from the previous comparison that was just finished, and the other is a new preset from the list of remaining presets that have not been used in all of previous comparisons. In another embodiment, 230 shown at the method draws two presets from the list of all presets that have not been compared against each other. Furthermore, audiologic rules such as the monotonic rule of volume can be incorporated to reduce the number of comparisons.

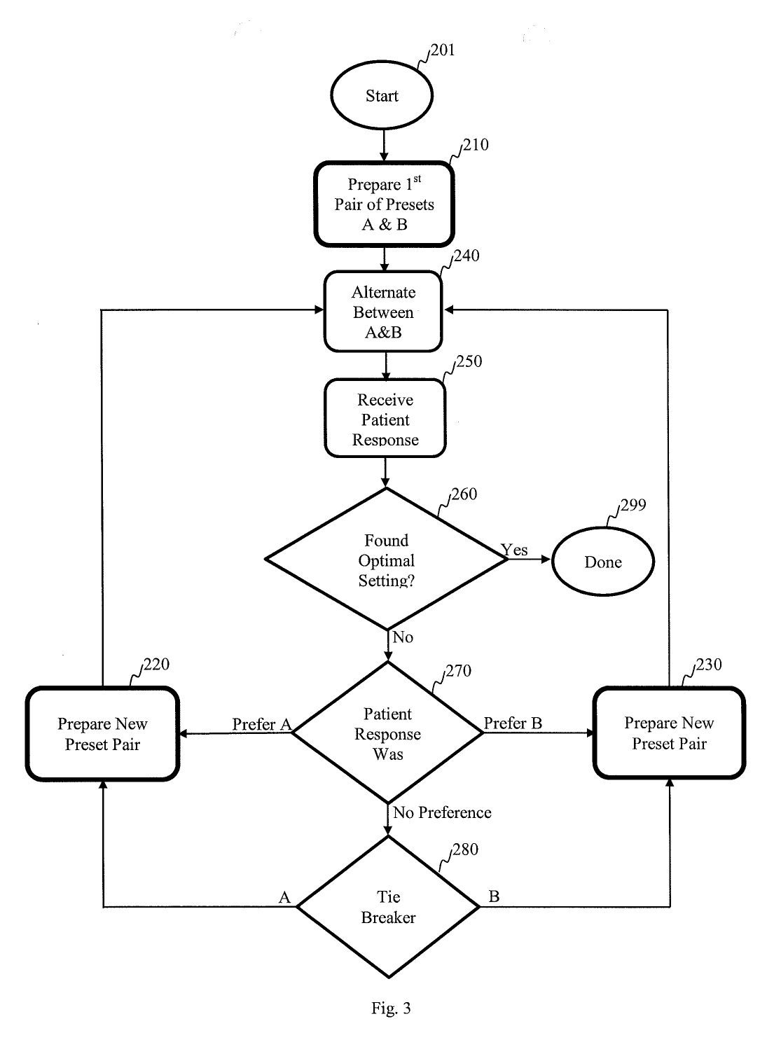

The search engine described above with reference to FIGS. 3-6 can be executed repetitively for more than one round. In the initial round(s), the difference between the presets is large. In the later round(s), the difference is small. One of the presets for the next round can be the winning preset from the previous round.

The search engine illustrated in and described above may also be implemented into a hearing device, as illustrated in. The hearing device includes components that can be found in hearing devices in the art, such as microphone 350, analog to digital (ND) converter 360, Signal Processing & Amplification Circuit & Software 370, digital to analog (D/A) converter 380, transducer 390, Memory 330, Communication Interface 310 for configuring and programming the hearing device using a computer or a fitting apparatus. As one of the preferred embodiments, the hearing device may also include a Search Engine 320 for searching the optimal setting for the hearing device. The operation of the Search Engine 320 is similar to that illustrated in FIG. 3 and described above. The Communication Interface 310 can be extended to further include the communication component for communicating with an external communication apparatus 100c which can used by patient for selecting which preset to listen to and which preset is being preferred. The operation of the communication apparatus is similar to that illustrated in FIG. 1A and FIG. 2.

One of the advantages of the current invention is that it uses the known hearing loss information to calculate the initial preset which would be the best possible setting for average patients with similar hearing loss. Further adjustment is only for the individual preference and the range of the adjustment can be relative small. It is possible to make the number of the presets for paired comparison small so that it is fast to complete.

Another advantage of the current invention is that it allows no preference response during the paired comparison and uses an objective tie-break rule to decide which preset would benefit patient better. This allows patient to focus on the obvious difference between the presets and proceed fast if they cannot tell the difference easily. The patient will less likely get frustrated and final outcome is more likely to provide best benefits to the patient.

What is claimed is:

1. An apparatus for fitting hearing device includes:
a search engine for searching the optimal settings of a hearing device;
a first selector for patient to alternate the hearing device between two presets;
a second selector for patient to register the preference or no preference of the two presets; and
the said search engine includes a tie-break component for deciding which preset is better if patient registers a no preference response.

2. An apparatus according to claim 1, where the tie-break component calculates an index that is related the speech intelligibility.

3. An apparatus according to claim 1, where the search engine is a paired comparison procedure.

4. An apparatus according to claim 3, where the paired comparison procedure operates to calculate an initial preset from patient's hearing loss data.

5. An apparatus according to claim 4, where the paired comparison procedure operates to creates more presets from the initial preset.

6. An apparatus according to claim 3, where the paired comparison procedure operates according to round robin.

7. An apparatus according to claim 6, where the round robin is modified according to one or more audiologic rules to reduce the number of paired comparisons.

8. An apparatus according to claim 7, where one of the audiologic rules is a monotony rule of volume.

9. Apparatus according to claim 5, where the paired comparison procedure is executed multiple times, each time with a new set of presets.

10. Apparatus according to claim 9, where the new set of presets for the next round of the paired comparison procedure includes the winning preset from the previous round of the paired comparison procedure.

11. Apparatus according to claim 9, where the differences between presets for a later round of the paired comparison procedure is smaller than the difference between presets for an earlier round of the paired comparison procedure.

12. A hearing device fitted according to claim 1.

13. An apparatus for fitting hearing device includes:
a paired comparison procedure for searching the optimal settings of a hearing device;
a first selector for patient to alternate the hearing device between two presets;
a second selector for patient to register the preference or no preference of the two presets; and
the said comparison procedure includes a tie-break component for deciding which preset is better if patient registers a no preference response.

14. An apparatus according to claim 13, where the tie-break component calculates a speech intelligibility index to decide which preset is better.

15. Apparatus according to claim 13, where the paired comparison procedure is executed multiple times, each time with a new set of presets.

16. Apparatus according to claim 15, where the new set of presets for the next round of the paired comparison procedure includes the winning preset from the previous round of the paired comparison procedure.

17. Apparatus according to claim 15, where the differences between presets for a later round of the paired comparison procedure is smaller than the difference between presets for an earlier round of the paired comparison procedure.

18. A method for fitting hearing device includes:
a search engine for searching the optimal settings of a hearing device;
a first mean for patient to alternate the hearing device between two presets;
a second mean for patient to register the preference or no preference of the two presets; and
the said search engine includes a tie-break mean for deciding which preset is better if patient registers a no preference response.

19. A method according to claim 17, where the tie-break mean calculates an index that is related the speech intelligibility.

20. A method according to claim 18, where the search engine is a paired comparison procedure.

21. A method according to claim 20, where the paired comparison procedure operates to calculate an initial preset from patient's hearing loss data.

22. A method according to claim 21, where the paired comparison procedure operates to creates more presets from the initial preset.

23. A method according to claim 20, where the paired comparison procedure operates according to round robin.

24. A method according to claim 23, where the round robin is modified according to one or more audiologic rules to reduce the number of paired comparisons.

25. A method according to claim 24, where one of the audiologic rules is a monotony rule of volume.

26. A hearing device fitted according claim 18.

27. A computer readable medium including executable instructions operating according to the method in claim 18.

28. A smartphone readable medium including executable instructions operating according to the method in claim 18

29. A method according to claim 20, where the paired comparison procedure is executed multiple times, each time with a new set of presets.

30. A method according to claim 29, where the new set of presets for the next round of the paired comparison procedure includes the winning preset from the previous round of the paired comparison procedure.

31. A method according to claim 29, where the differences between presets for a later round of the paired comparison procedure is smaller than the difference between presets for an earlier round of the paired comparison procedure.

32. A hearing device compromises:
At least one microphone for converting acoustical signal into electronic signals;
An electronic circuit for processing the said electronic signals to produce processed electronic signals;
A transducer for converting the processed electronic signals into signals having another type of energy format;
A communication interface for receiving patient selections from an external apparatus;
A search engine for searching the optimal setting for the hearing device. The said search engine includes the tie-break component for deciding which preset is better when patient cannot tell the difference between presets.

33. A hearing device according to claim 32, where the said transducer is a speaker that converts electronic signals into acoustic signals.

34. A hearing device according to claim 32, where the said transducer is a transceiver that converts electronic signals into electromagnetic signals.

35. A hearing device according to claim 32, where the said transducer is a vibrator that converts electronic signals into mechanical vibrations.

36. A hearing device according to claim 32, where the communication interface operates to receive patient selection for toggling between two presets.

37. A hearing device according to claim 32, where the communication interface operates to receive patient selection of preference about the two presets.

38. A hearing device according to claim 37, where the patient selection of preference include no preference.

39. A hearing device according to claim 32, where the tie-break component calculates an index that is related the speech intelligibility.

40. A hearing device according to claim 32, where the search engine is a paired comparison procedure.

41. A hearing device according to claim 40, where the paired comparison procedure operates to calculate an initial preset from patient's hearing loss data.

42. A hearing device according to claim 41, where the paired comparison procedure operates to creates more presets from the initial preset.

43. A hearing device according to claim 40, where the paired comparison procedure operates according to round robin.

44. A hearing device according to claim 43, where the round robin is modified according to one or more audiologic rules to reduce the number of paired comparisons.

45. A hearing device according to claim 44, where one of the audiologic rules is a monotony rule of volume.

46. An apparatus that is used to communicate with the hearing device according to claim 45.

47. A hearing device according to claim 40, where the paired comparison procedure is executed multiple times, each time with a new set of presets.

48. A hearing device according to claim 47, where the new set of presets for the next round of the paired comparison procedure includes the winning preset from the previous round of the paired comparison procedure.

49. A hearing device according to claim 47, where the differences between presets for a later round of the paired comparison procedure is smaller than the difference between presets for an earlier round of the paired comparison procedure.
